(19) United States
(12) Patent Application Publication
(10) Pub. No.: US 2020/0005213 A1
(43) Pub. Date: Jan. 2, 2020

(54) SYSTEM AND METHOD TO MONITOR, ALERT AND PREDICT PRECURSORY BEHAVIOR

(71) Applicant: Jo Lynn J. Clemens, Scottsdale, AZ (US)

(72) Inventor: Jo Lynn J. Clemens, Scottsdale, AZ (US)

(21) Appl. No.: 16/457,491

(22) Filed: Jun. 28, 2019

Related U.S. Application Data
(60) Provisional application No. 62/691,430, filed on Jun. 28, 2018.

(51) Int. Cl. G06Q 10/06

(52) U.S. Cl. CPC G06Q 10/06398; G06Q 10/063114

(57) ABSTRACT

A multi-stack software solution including artificial intelligence and blockchain to reduce employer liability and insurer risk is disclosed. Through ongoing and real-time assessment, the system curbs employer negligence through crime or fraud deterrence, re-enforcement of policies, obtaining information to assist in prevention, and providing continual recommendations for improvement.

### CROSS-REFERENCE TO RELATED PATENT APPLICATIONS

This application claims priority to U.S. Provisional Patent Application Ser. No. 62/691,430, filed Jun. 28, 2018.

### BACKGROUND OF THE INVENTION

### 1. Field of the Invention

The present invention relates generally to systems and methods to assess, predict, and mitigate employer risks and more particularly to a multi-stack software solution including artificial intelligence and blockchain to reduce employer, consumer and insurer risk and serve as a monitoring and diagnostic tool.

### 2. Description of Related Art

Crime and fraud by employees, contractors and vendors is typically not discovered until 18 months post inception typically through third party audits, post exorbitant property damages, physical injury, or by an internal whistleblower. Damages resulting from hiring the wrong worker or vendor include increased financial, premium, and reputational costs. Through the use of technology and advance recognition of the occupational behavioral flags, which contribute to both crime and fraud, organizations are better equipped to detect fraud and mitigate losses.

From a legal standpoint, when an organization can show that they have met their standard of duty to protect the general public from the acts of their workers/agents, exposure to high settlements and judgments is reduced.

When the incidence of insurance losses predicated on crime and fraud reduce, an organization's premiums are stabilized relative to the reduced risk exposure.

Insurers can benefit from real-time perspective of the condition of the worker risk through the sharing of the score and policies and practices currently implemented to address worker risk.

Consumer trust is maintained when the reputation of an organization is not fraught with safety and security concerns stemming from the actions of its employees, contractors and vendors.

New legislation prevents background checks in advance of hire and long-term workers are found not to receive adequate, monitoring, supervision or screening after they have been hired. There is no long-term deterrent to prevent crime and fraud from occurring.

Embezzlement, identity theft and violent crimes are on the rise. These types of crimes are projected to remain on this continuum as fewer workers are considered employees and as a result of the growth of remote workers and the gig economy.

Insurance policies rarely cover negligent hiring, retention and supervision, and human resource policies are not considered sufficient as they are reviewed only at time of hire.

Through ongoing and real-time assessment, the system curbs employer negligence through crime or fraud deterrence, re-enforcement of policies, aggregation of information to assist in prevention and continual recommendations for improvement.

The present invention allows employers to predict, prevent and monitor their business risks and serves as a risk mitigation solution that also works for diagnostics in any industry. The platform of the present invention addresses employer liability risk and associated costs while also reducing insurer risk exposure. The platform may be utilized for other areas, including but not limited to, insurance, risk management, human resources and diagnostics in other industries.

A need therefore exists for a state of the art, real-time technological solution using more sophisticated systems to monitor, alert and predict precursory behavior to prevent both crime and fraud from occurring. Moreover, there is a more general need to afford transparency in the human capital supply chain so that all affected parties are committed to and stand to benefit from maintaining a safe and secure, workplace and society.

### SUMMARY OF THE INVENTION

The present invention overcomes these and other deficiencies of the prior art by providing a system and method to monitor, alert and predict precursory behavior. The method includes the steps of: determining a source of information specific to occupational behaviors; obtaining from one or more of the determined sources, a plurality of predetermined factors associated with an organization and at least one employee of that organization; generating a risk score associated with the organization based on its employee's occupational behaviors; continuously updating the predetermined factors obtained from one or more of the determined sources; analyzing the plurality of factors obtained from one or more of the determined sources; producing updated prediction models for recommendations; and generating recommendations to the organization for improving the risk score and reinforcing compliance.

It is to be understood, that an object of the system and method of the present invention is to encompass the entirety of an organization and of an employee's career.

Although the present invention is described and illustrated in the context of an organization and employees, it is to be understood that the disclosure of the present invention is not limited to this embodiment but is equally applicable to additional industries in general wherein the disclosed system and methods are advantageous.

The foregoing, and other features and advantages of the invention, will be apparent from the following more particular description of the preferred embodiments of the invention, the accompanying drawings, and the claims.

### BRIEF DESCRIPTION OF THE DRAWINGS

For a more complete understanding of the present invention, and the advantage thereof, reference is made to the ensuing descriptions taken in connection with the accompanying drawings briefly described as follows:

FIG. 1 illustrates a process flow of the high level architecture according to an embodiment of the invention;

FIG. 2 illustrates a process flow of the system's employer workflow in the context of insurance according to an embodiment of the invention;

FIG. 3 illustrates a process flow of the system's employer workflow in the context of risk-modeling according to an embodiment of the invention;

FIG. 4 illustrates a process flow of the system's employer workflow in the context of onboarding according to an embodiment of the invention;

FIG. 5 depicts a non-limiting example of the system's blockchain driven risk modeling according to an embodiment of the invention;

FIG. 6 depicts a non-limiting example of the system's employee on-boarding workflow according to an embodiment of the invention;

FIG. 7 depicts a non-limiting example of the system's workflow for chatbot recommendations according to an embodiment of the invention;

FIG. 8A depicts a non-limiting example of an overall organization of the control panel according to an embodiment of the invention;

FIG. 8B depicts a non-limiting example of the Worker IQ associated with the My IQ workflow of FIG. 8C according to an embodiment of the invention;

FIG. 8C depicts a non-limiting example of the My IQ workflow associated with the Worker IQ of FIG. 8B according to an embodiment of the invention;

FIG. 8D depicts a non-limiting example of the Worker IQ associated with the Employer IQ workflow of FIG. 8E according to an embodiment of the invention;

FIG. 8E depicts a non-limiting example of the Employer IQ workflow associated with the Worker IQ workflow of FIG. 8D according to an embodiment of the invention;

FIG. 8F depicts a non-limiting example of the Employer IQ workflow according to an embodiment of the invention; and

FIG. 9 depicts a non-limiting example of the system's metric scoring workflow according to an embodiment of the invention.

### DETAILED DESCRIPTION OF EMBODIMENTS

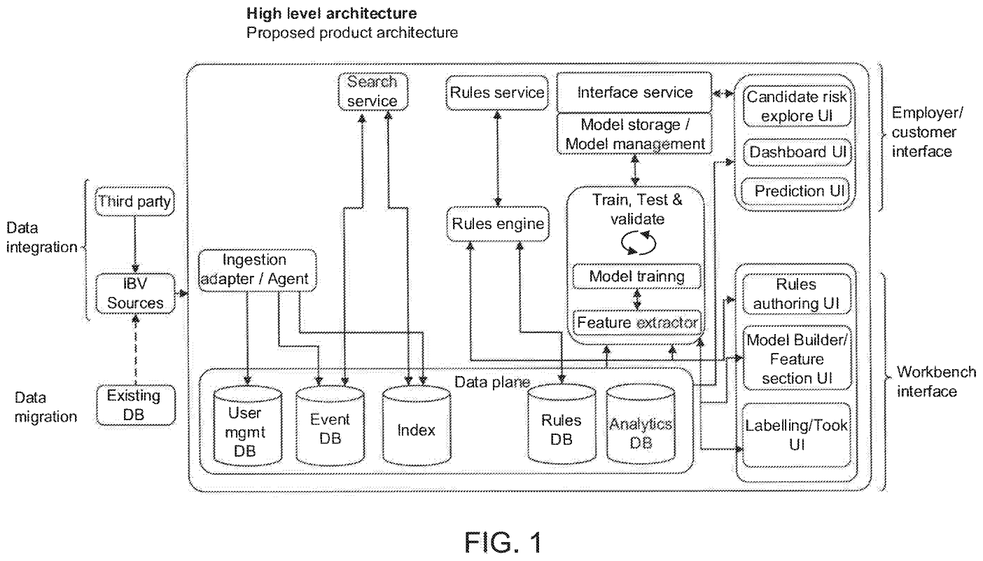

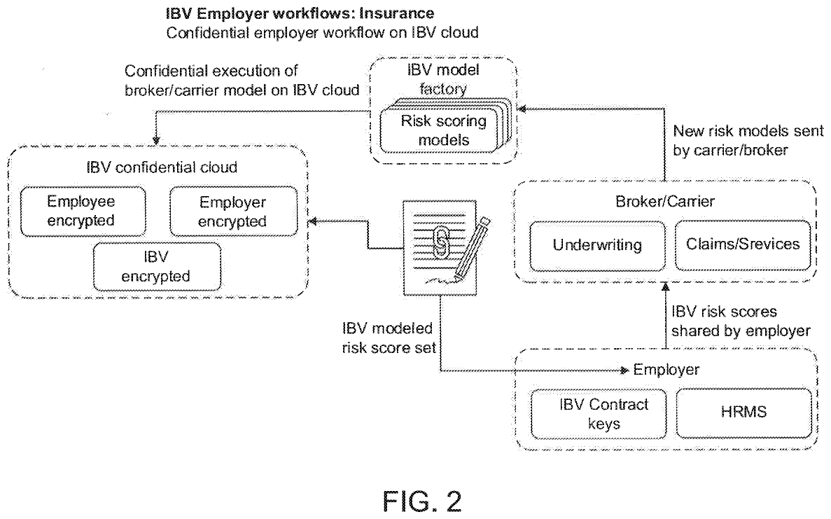

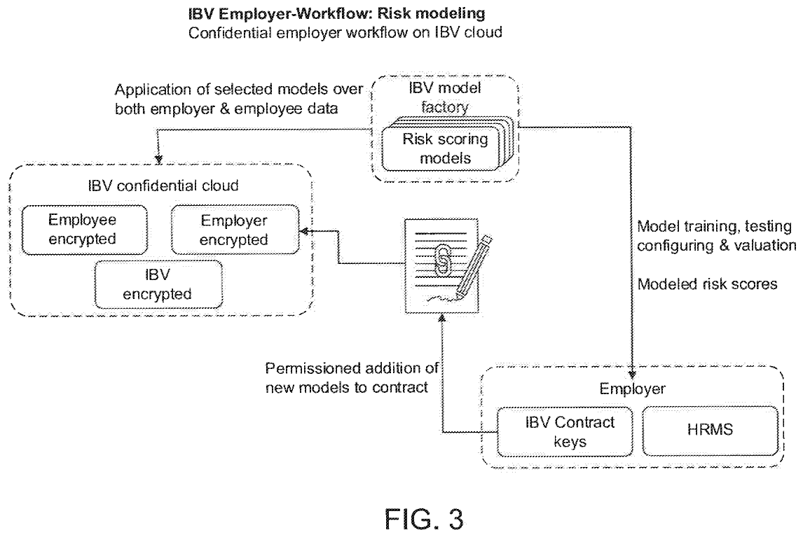

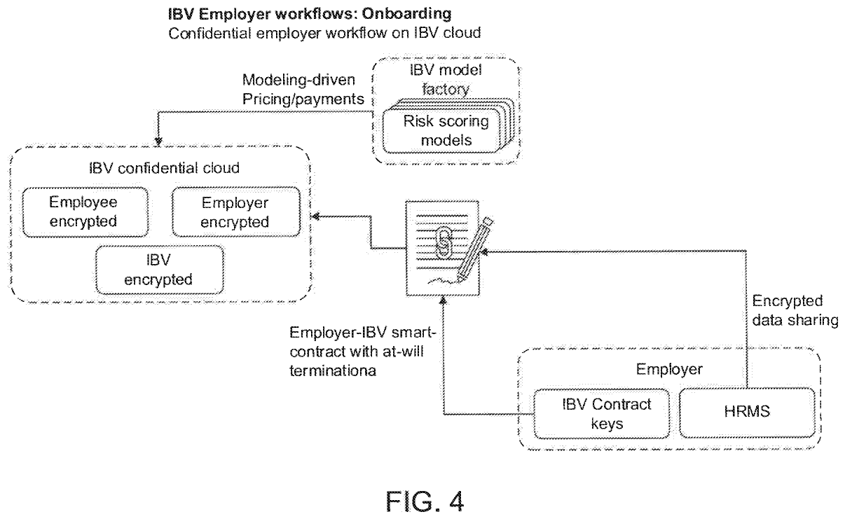

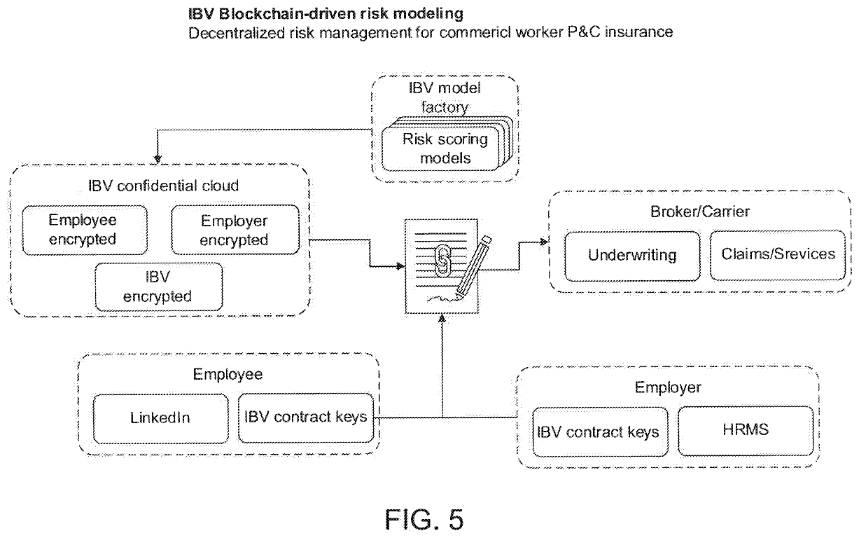

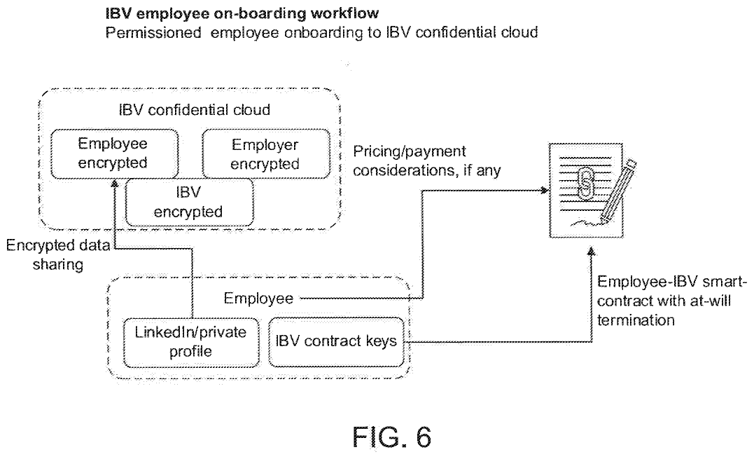

Further features and advantages of the invention, as well as the structure and operation of various embodiments of the invention, are described in detail below with reference to the accompanying FIGS. 1-9.

### Definitions

As used herein, “Metrics Scoring” refers to measurements that reflect the performance of an employer's risk reduction techniques or a worker's occupational behavior health towards following policies and procedures and engaging in the advancement of organizational goals.

As used herein, “Risk Profile” refers to a composite identity and/or measure of threats to which an organization is exposed or the measure of risk presented by a worker based on past behaviors.

As used herein, “Risk Reduction” is sometimes referred to as loss mitigation and refers to a risk management technique whereby an organization or an insurer will implement measures to prevent actualizing risks or minimizing the number that can actually happen.

As used herein, “HRMS Systems” or Human Resource Management System refers to a form of human resource software that combines a number of systems and processes to ensure the easy management of human resources, business processes and data.

As used herein, “Payroll Management System” refers to the financial aspects of employee's salary, including allowances, deductions, gross pay, net pay, etc.

As used herein, “RMIS” or Risk Management Information System refers to assistance in consolidating claims, policy and exposures information, and providing the tracking and management reporting capabilities to enable the user to monitor and control the overall cost of the risk.

As used herein, “Loss Control” refers to a risk management technique that seeks to reduce the possibility that a loss will occur and reduce the severity of those that do occur.

This invention allows employers to predict, prevent and monitor their employer liability risk and associated costs while also reducing insurer risk exposure. The invention claimed here solves the crime or fraud consequences for employers to include spiraling costs and reputation damage from hiring the wrong worker (contractor or employee) and serves to deter fraudulent actions by workers through real time monitoring. The system reduces the risk through monitoring workers throughout their career for factors shown to increase the likelihood that a crime will occur by extracting information on these proprietary factors from the employer and through their existing HRMS, Payroll and Risk Management systems. Once the information is extracted through API connection to noted systems, it is entered into a database upon which the system's proprietary algorithm will assess a score relative to the likelihood towards fraud. The score is transparent to the worker who can improve the score by taking compliance courses and changing behaviors. Worker risk profile includes licenses and certificates and a skill sweep from LinkedIn for the employer. Practices and policies are researched through a self-audit process whereby the employer acknowledges or disavows the recommended practices and stores proof of same (such as an Human Resources manual) in a designated folder on their server, which may be uploaded to the system and scanned using artificial intelligence to confirm the document as named. Further, through a permission based system, the employer can request that we share with their insurer, broker or other entities seeking such score and audit documents.

The system provides an ongoing snapshot of an employer's liability risk and loss control recommendations surrounding the reduction to negligent hiring risks and best practices in human resource management such as financial crime policies with annual training, active shooter training, dual signatory processes, separation of duties, etc. to reduce risk. The platform also affords a portable risk profile for both the employer and the workers through a permission based encrypted transfer process from the employer/organization to the insurer or the worker to their next potential employer/organization through smart contracts or encrypted file transfer systems and portable background history to include automated ongoing checks.

The claimed invention differs from what currently exists. Currently, employers rely on their insurance policy and human resource departments at the time of hire to address risks presented by employees, contractors or vendors. The system provides a solution that conducts real-time and comprehensive risk analysis before and after an employee, contractor or vendor is retained.

Workers are added to the SaaS based platform. The organization's HRMS, payroll and RMIS systems are accessed to track, in real-time (as identified red flag changes occur), specific occupational behaviors extracted from the organization's existing records through API. In addition, changes in behavior are noted through changes to the Metric Score as shown in the secured dashboard. A Metric Score is assessed based on a proprietary algorithm that serves to represent changes in worker behavior/actions that have shown to contribute towards crime and fraud. The score and the key behavioral aspects which make up the score are visible to both the organization and to the worker, to allow the worker to improve their behavior to better their score and their individual Risk Profile.

Workers can also improve their score through compliance and on the job training. In advance of hire by a new employer, a worker can request a worker risk profile transfer to the next potential employer, which, if favorable, can improve their chances of hire and assist the new employer in assessing the risk of the worker candidate.

Employers/organizations are also subject to a self-audit of their practices and policies surrounding worker compliance and training. Organizations receive a score based on a combination of their existing compliance policies and practices and the average worker metric scores for the organization. Using machine learning, organizations receive risk reduction recommendations by department, that, when implemented, improve the score for the organization and, indirectly, the score for the workers. As organizations continue to improve their compliance policies and training practices to include ongoing monitoring of worker behaviors, a real-time snapshot of the organization's risk profile is developed. This risk profile snapshot, to include tailored filters and reports of worker risk assessments, can be used to assist the organization with strategic decision making, risk mitigation and prevention and potentially reduced premiums through the sharing of the organization's risk profile with the broker, insurer or via smart contracts to Canopy, the insurance industry's blockchain, using smart contracts.

Additional risk mitigation techniques are garnered from trusted online compliance resources through web data scraping. The data is cleansed, structured and placed into departmental silos within the cloud and introduced into the machine learning recommendation engine for ongoing suggested risk updates to the organization. As additional mitigation techniques are added, the scoring algorithm automatically adjusts to incorporate it.

The disclosed system is a multi-stack diagnostic loop and risk mitigation platform that helps users to identify, predict, prevent and mitigate problems and/or damages; that takes in inputs, creates portable encrypted smart contracts profiles; and identifies issues and assigns a score using a proprietary algorithm. The platform further looks at policies and practices that are in place to make recommendations based on machine learning through real-time audits and recommendations. Further, chatbot recommendations are garnered from ongoing web scrapes from trusted compliance resources. Financial costs are reduced through addressing identified hazards in any industry and scores can be shared for further cost savings with financial institutions, mergers and acquisitions, audits, diagnostics, insurance companies, healthcare and governmental entities along with a host of other organizations. It is designed to become best practices for multiple industries and to demonstrate a higher level of social responsibility.

The Workbench acts as administration for onboarding of new clients; maintenance of database; file transfers; revenue share and vendor management; payment administration; discounts; data modeling and algorithms; update risk recommendations; and reports.

Using the Employer/Customer interface, the system administrators can make required adjustments to data fields, partnerships, payments and subscriptions and the manner in which data is interpreted through data modeling and algorithms based on permission levels to include sales, executive staff and IT. Product selection occurs through the onboarding process and login credentials are provided for the following monthly subscription products as selected; Worker IQ, My IQ, (included with Worker IQ) and Employer IQ, which can be purchased separately or in conjunction with Worker IQ.

Worker IQ serves as the SaaS based dashboard for the employer. Through the user secured dashboard, the employer logs on, selects additional products and adds credit card details and uploads workers to be assessed either through bulk upload or manually. If the credit card is valid and background monitoring with Metric Score Factors or solely Metric Score is selected, the employer can opt to connect to their existing HRMS, Payroll or Risk Management, which will in turn extract pertinent details as they relate to subject occupational factors or the employer can manually enter the information. Employer has the ability to filter by region, department, occupation, status of checks and worker details. The algorithm dynamically adjusts the Metric Score based on real-time information from the systems. Data visualization graphs are updated based on data and scoring.

Beyond per worker scoring, the platform assessed an average score for the organization for all workers, later to compare to the industry benchmark. Specified risk specific background checks are run through FCRA compliant vendor partners and automated based on employer selected intervals. The Metric Score is auto adjusted based on results. Whenever background checks are included in the package, the employer is required to select a payment tranche (like a gift card for specified amount with buy down through product purchases) that will automatically recharge/refill their credit card below a certain percentage as products are purchased.

Vendor partners can also be selected from the product list, whereby, results of scoring processes applicable to each employee as determined by the vendor partner are also displayed within the employer list. For example, Service Guru provides worker ratings based on customer Feedback. A refer button in the Worker IQ dashboard permits Employer/Clients to refer other businesses to include but not limited to, contractors and subcontractors, to utilize the service.

Lastly, employers can input three strengths of the worker (drop down), which are shared with the worker in the My IQ profile.

The My IQ is a separate logon afforded to the worker through My IQ dashboard. The dashboard is mobile optimized and allows the worker transparency into some key factors which establish their worker score. Upon logon, the worker can view worker detail such as the variables serving as input for the factors, their Metric Score, and expanded history of any background checks initiated. The system may be configured to upload current driver's license and photo, upload licenses and certificates, data from LinkedIn, and permit the worker to state a desired position and receive skill recommendations based on professionals currently on LinkedIn with said position. The system may include recommendation of soft skills, permission-based sharing of risk profile with their next potential employer through encryption or smart contracts.

Employer IQ dashboard is a separate product that can be purchased alone or with the Worker IQ product. When purchased with the Worker IQ product, the baseline score for the platform becomes the average score for all workers as pre-calculated from the Worker IQ dashboard. Employer receives logon details and signs in with authentication. The employer enters demographic details and adds their credit card. Employers are advised to create a separate and secured system folder on their server to store all documents on the audit list, which may be utilized for the Risk Profile port. On the Self Audit Page, employer is instructed to identify key management with information to complete the required audit information, which may be from separate departments like HR, payroll, IT, accounting, etc. An email is sent to the key contact within the department and the audit chatbot conducts an audit through a series of questions which update based on responses in the audit list and later assesses a score for the employer.

Once recommended policies are implemented, the score can be improved.

Referring now to FIG. 1. is disclosed a High Level Architecture of the system. The system includes two control centers—a Super Admin (Employer/Customer Interface) and a Workbench or Sandbox (Workbench Interface).

The Employer/Customer Interface includes a software as a service (SaaS) based dashboard for the Employer and the Worker (Candidate) as well as a Super Admin sign in for the system to onboard clients and manage accounts. Trained algorithms are also included through the Feature Selection module.

The Employer/Customer Interface by way of the Admin dashboard will be used by the system's Super Admins to create organization accounts for clients. Admins can complete the onboarding process to include industry code retrieval, main subscriptions, and coupons.

The Employer/Customer Interface may also include contact and Application Programming Interface with details for integration with any existing HRMS systems, payroll, risk management and other third party integrations. The system is therefore configured to pull data into platform from these integrations. The system also contemplates the ability to add custom integrations to an existing product section list or any existing interfaces and may be plugged in to the composite value of “Additional Assessments.”

Once the above steps are completed, the organization Admin will receive email notification with a welcome email and credentials to access organization's dashboard.

Trained and tested algorithms, recommendations and rules are also housed in the Employer/Customer Interface and can be combined into products via a selection feature

The Workbench Interface houses the rules sandbox and risk modeling tools, feature lists, algorithm authoring as well as labeling tools to identify key process components. The Workbench features and models are continually tested, trained and validated. Once validated, models and features are stored until requested through inference service by the system Admin, employer or worker.

The system has a data integration feature. Data will be ingested from the existing system database and/or other third-party data sources. The system includes an ingestion adapter/agent, which will pull data from respective data sources and stores the data into a normalized data store.

The system includes a data management feature, which allows for user management including general user management and book keeping.

The system includes an event database, wherein all events are normalized and stored.

This is a multimodal database supporting both SQL and programmatic access. All the events and associated metadata is indexed in an elastic search index for easy search including other information search routines.

The system includes built-in analytics, both real-time and offline analytics, which are stored in MongoDB or like database management system.

The system includes rules adaptor stored in a MongoDB based rules database.

The system includes a search service wherein all the event data and risk metadata is stored in an Elastic Index. Search services use an enhanced BM25 algorithm or like algorithms for multimodal search and also for any other information retrieval tasks.

The system includes a rules engine and management module. The rules engine is based on DROOLS. All the rules are externalized. The system includes tools to author or import the rules, scalable rules inference services, and a rules user interface to author rules.

The system provides for analytics including Java based analytics services. In some embodiments, the system may have analytics builders for selecting data elements and respective trends.

The system includes a user interface, which may be a React/Vue.js JavaScript based user interface. The user interface is configured for feature selection and training and may also include a data labeling user interface for machine learning.

In that regard, the system may be configured for machine learning. The system includes a feature extractor to extract features from data for machine learning algorithms. These will be both manual and semi-supervised using techniques like PCA. This module is an end-end pipeline for model training based on Tensorflow. The system is configured to train, test and validate routines by splitting the datasets appropriately. Validation is done using manual, k-fold, F1 and AUC. Trained models are serialized and stored in ModelDB. The machine learning inference engine will download the latest model from ModelDB and run inferences on the data stream.

Full-fledged model usage statistics and dashboard are available. In some embodiments, the system may include analytics builders for selecting data elements and respective trends.

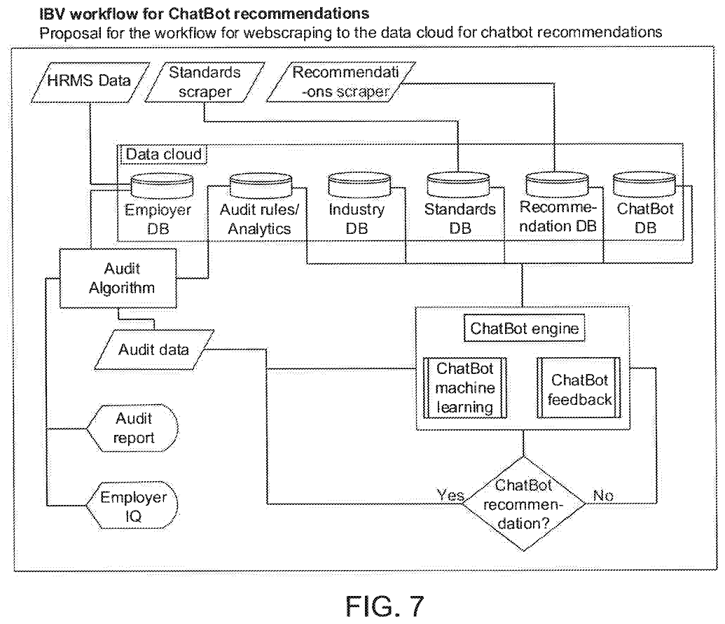

Referring to FIG. 7, the chatbot recommendation works from employer audit data and data pulled from various webscraping algorithms and resides with the Workbench/Sandbox referenced in the High Level Architecture diagram.

Data for industries, standards, and recommendations are pulled from the web via webscraper and stored in the Data Plane. The webscapers will crawl industry relevant sites for best practice information on compliancy issues, improving industry standards, and risk reduction recommendations. These webscrapers are to continuously update industry information and feed into the data cloud.

Audit data is initially collected from the employer and inputed into the Audit Algorithm. The Audit Algorithm is set by the rules and analytics database located in the data plane and continuously updated by the Rules Service and Rules Engine in the Workbench/Sandbox. The chatbot engine pulls the results from the Audit Algorithm and matches to standards and best practices for the different compliancy and risk factors within the industry. The chatbot engine then matches those standards to recommendations from the recommendations database and previously recorded recommendations based on the results of the Audit Algorithm. These are also updated continuously through machine learning within the Workbench/Sandbox. Through user feedback and new best practice/standards the chatbot engine will produce updated prediction models for providing recommendations.

The chatbot results are a series of recommendations which the end user can respond to. If the end user follows the recommendations from the chatbot, this information is fed back into the audit data which updates through the Audit Algorithm to find new recommendations. This will also update the Employer IQ and Audit Report visible to the end user.

How the end user responds to the chatbot (either a positive or negative response to recommendations) is fed back into the chatbot engine and stored in the chatbot database for learning on improved or changed recommendations.

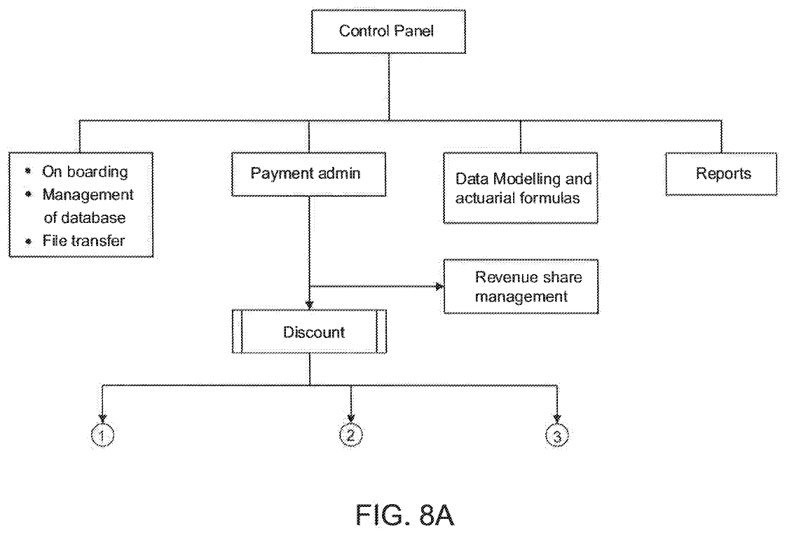

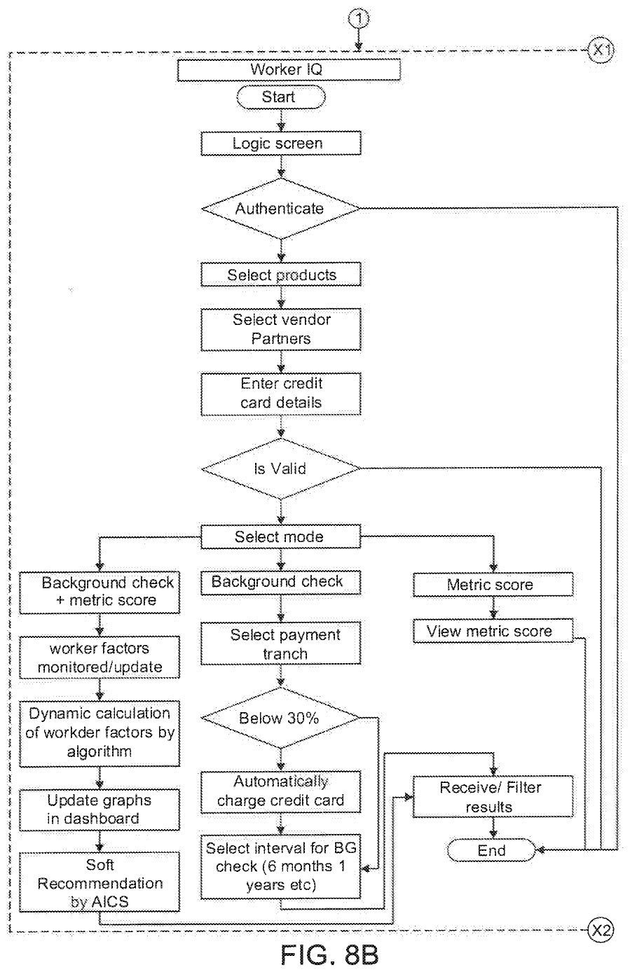

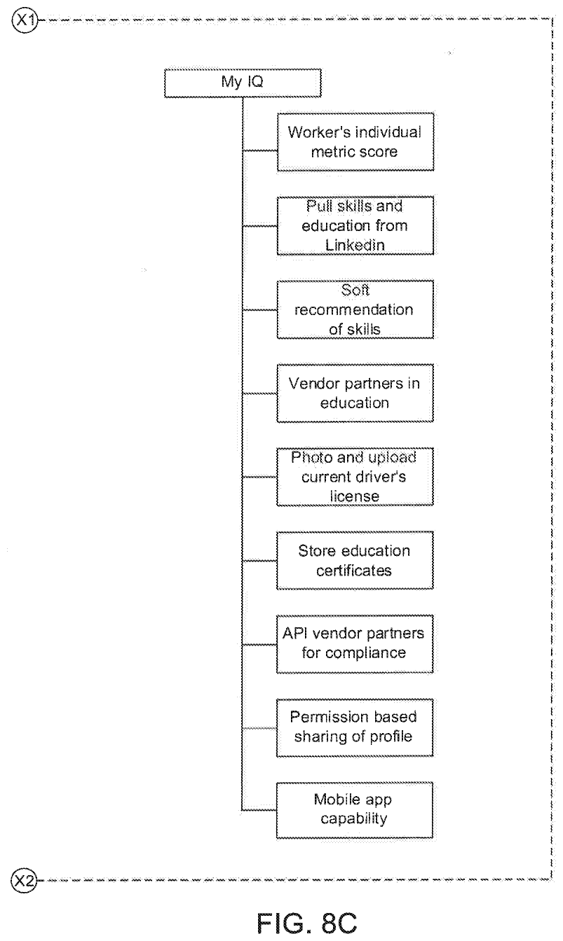

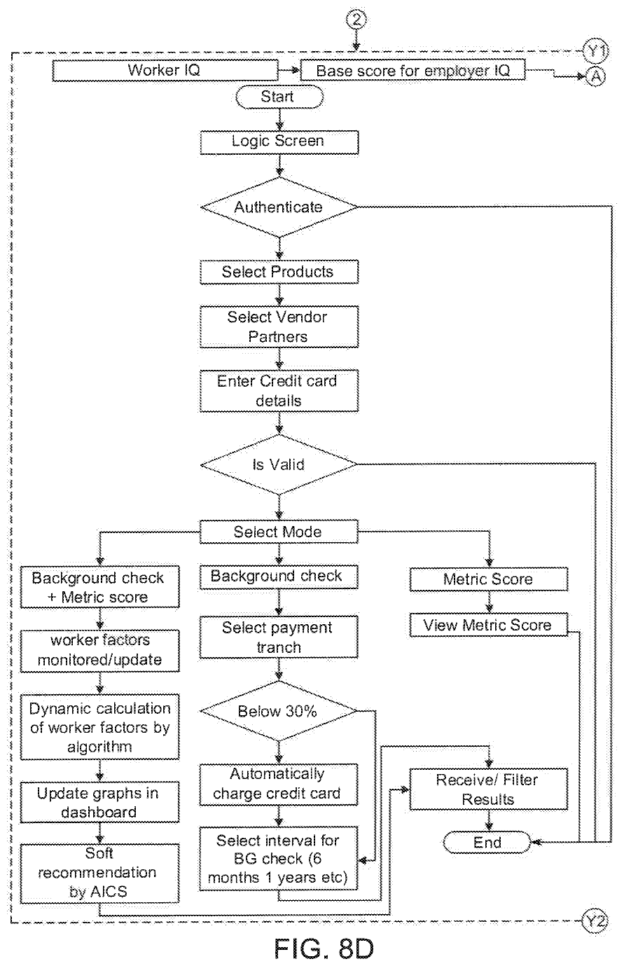

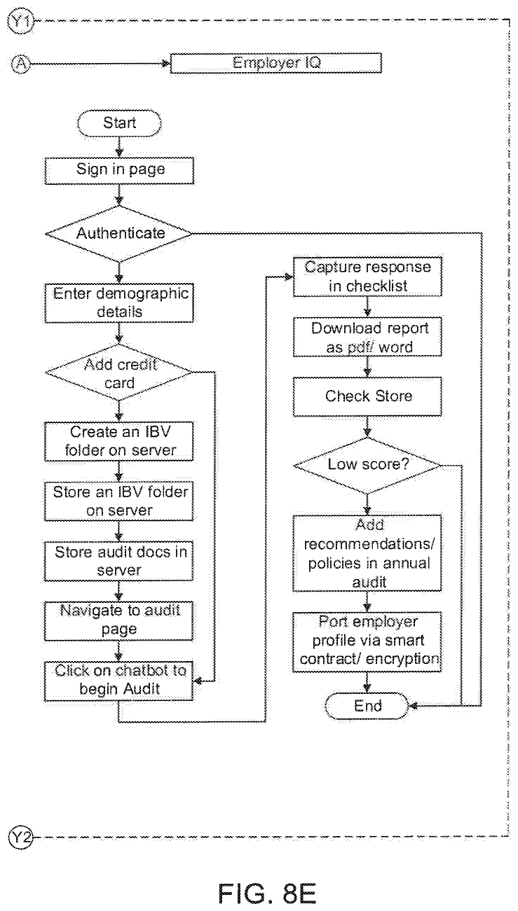

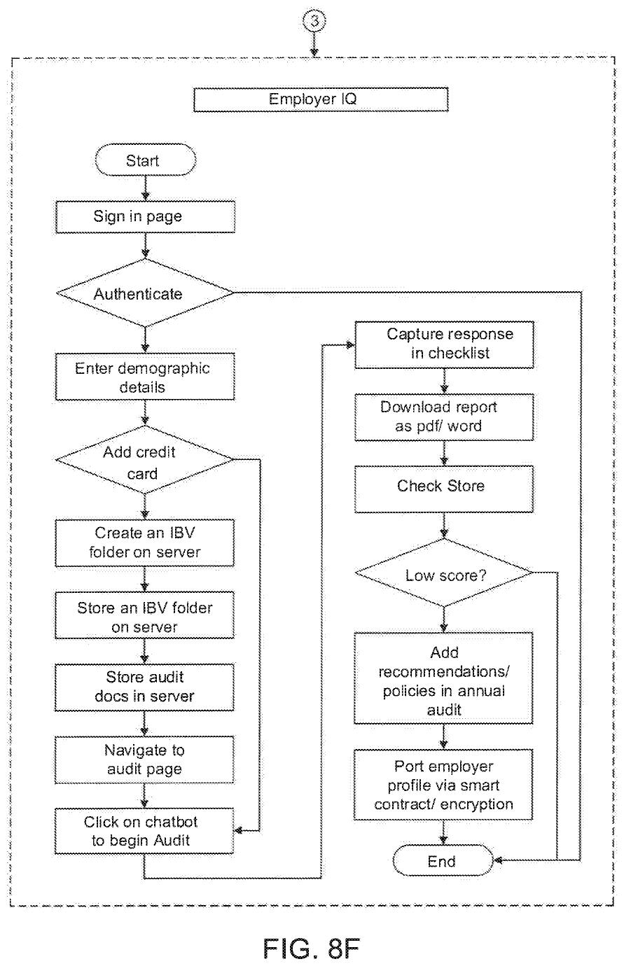

Referring to FIGS. 8B, 8C, and 8D is disclosed a platform for the Worker/Contractor. The Worker/My IQ is provided for use by an Employer/Organization's workers and contractors whenever the Worker IQ (Employers view of their workforce) is purchased. In the My IQ dashboard, there is a unique login for every worker to include an auto generated password and Username, which may be their first initial, middle initial and last name. My IQ is the Worker's own Risk Profile which helps them promote internally for promotions or to increase hireability to another employer.

Through My IQ, the worker/contractor receives visibility to factors scored, ongoing changes in Metric Score, and receives updated risk recommendations. The system may collect data from LinkedIn including profile picture, skills and education updates. Workers and contractors may also be asked to upload their personal insurance cards.

The Worker can improve their Worker Risk Profile through the following: 1. Compliance training; and 2. Job related educational certificates.

The My IQ dashboard also includes API Vendor Partners such as Anonymous Reporting Permission based profile sharing, which may be to the next potential employer or business associates, through encryption and smart contracts.

The My IQ dashboard is also capable of being used as a mobile application.

Referring to FIGS. 8D, 8E, and 8F is disclosed a platform for the employer's use. Through a self-audit process, Employer IQ looks at the existing policies and practices of the employer to ascertain their strength towards reducing crime and fraud. Employer IQ is a separate standalone product with its own separate dashboard. Annual audits by preferred audit partners reinforce compliance and improve the employer's Metric Score. The Employer IQ does not look at the worker factors unless included together with Worker IQ, whereby the average score for workers becomes the baseline Metric Score for Employer IQ.

In the Employer IQ flowchart, there is a unique login for every employer. This login is set up by the system's Super Admin. If the employer adds credit card details and purchases the system, he/she can further access the system. Otherwise only the basic dashboard page is visible.

Once the card information is given the following tasks are possible:

1. The employer can create a secured system folder in which he/she can store audit documentation and Navigate to Audit Page;
2. Perform the audit via chatbot. A set of questions are put forward department wise which should be answered. This information is captured in a stored platform checklist that can be printed out later on;
3. The score can be improved upon by adding recommended risk reduction policies and practices and by submitting to an annual audit by our preferred vendor partners. The chatbot maintains all responses and updates the score as changes occur; and
4. Through data mining from reliable online third-party compliance resources, the recommendations are continually updated per FIG. 1.

The employer can be ported into smart contract or encryption for security purposes with permission-based file transfer to insurers, agents and/or business associates and connected to Canopy, the insurance industry's blockchain, to show real-time changes in risk condition, for favorable premium and financial outcomes.

Referring to FIG. 8D is disclosed the Worker IQ platform visible to the employers providing insight into their Workers. Worker IQ, gives the employer real time insights (through ongoing monitoring and updates) into the occupational behaviors of their workers by monitoring occupational behaviors that are precursors to crime and fraud and provides an average worker score for the organization. The platform helps employers to predict, prevent and mitigate crime.

There is transparency to the worker through My IQ referenced above in FIGS. 8B and 8C. The employer receives notification of unique sign on details and user permissions for assigned account contacts. Two additional sub-user permissions are provided for use.

If Employer IQ is added to the Worker IQ product—the same user permissions are used for both platforms. If the employer adds credit card details and purchases a product he/she can further access the system. Otherwise only the basic dashboard page is visible.

Once the card information is given the following tasks are possible:

1. Select default credit card;
2. Upload workers manually or via bulk upload through CSV or existing API integration;
3. Run ongoing post-employment check monitoring;
4. Select complementary partner products;
5. Run real-time metric scoring module for select workers to include the average score for an organization, from 1-10 with 10 being the best and base score;
6. Filter results by occupation, department and regions, etc.;
7. View visualizations of emerging risk patterns;

### 8. Run Risk Reports;

9. Receive soft risk control recommendations based on NAIC code to corresponding risk mitigation methods from AM Best;
10. Refer other vendors and partners to utilize the platform;
11. Opt to add employee factor data via API through HRMS, payroll and Risk Management systems;
12. Metric Score assessed and continually updated for each worker and the organization; and
13. Auto tracking of balance with ability to print a point in time invoice.

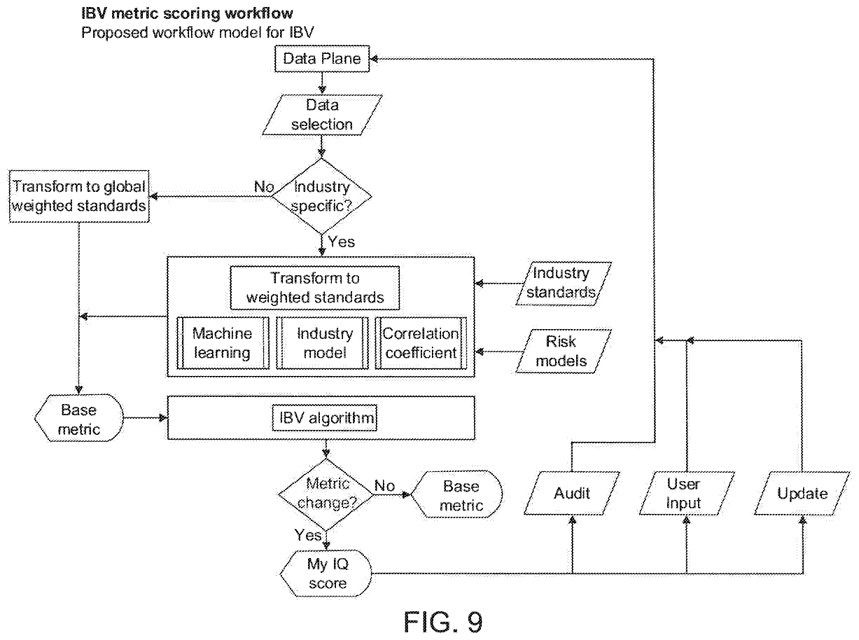

Referring to FIG. 9 is disclosed a Metric Scoring workflow. The Metric Scoring for the system works from updates in the data cloud where employer, audit, and industry relevant information is stored.

Data from the employer is selected from the database and determined whether to utilize either global weighted standards or industry specific weighted standards. The employer data is transformed into a base employer score and compared to baseline industry standards and current risk models. These include data gathered from responses submitted by the employer on various departments within the organization, i.e.: HR, Payroll, etc. The transformation engine also utilizes all employer data to learn and improve on industry factor weighting and assigning scores.

This produces a base Metric Score to which the system's algorithm is applied. Worker IQ scores are rated on a scale of 1-10 based on responses from the worker. These worker scores are normalized, averaged, and integrated into the Employer IQ score.

The Employer IQ Score can then be changed through providing additional employer information through implementing recommendations provided by the chatbot recommendation engine, audit, end user employer data input, or industry updates and fed back into the employer database. The workers are also given recommendations for improving their score through compliance and education training, etc. in their My IQ profile.

The software's artificial intelligence and machine learning makes recommendations on strategic loss control actions that can be taken to reduce prevent and control employer liability risk. Employer Risk profile is portable to the insurer via blockchain or other encrypted methods to provide accurate rating and assessment and employee, contractor and worker risk profile is portable using encrypted file transfer or smart contracts to their next employer via blockchain or encrypted methods to gain a vested interest in maintaining favorable conduct and reduce hiring times.

Insurance policies and human resource manuals are not specific to the business and their unique risks nor do they take into account actions by employees or contractors post-employment that can serve as indicators. The system captures unique risk profile information by tracking actual occupational behavior data and continually tracking the organization's current training and compliance procedures.

Through ongoing and real-time assessment, (using continual API data pulls through currently used HR, Payroll and Risk Management systems), our metric scoring solution curbs employer negligence through crime or fraud deterrence (as there is transparency to the worker on the status of the score), re-enforcement of policies (through the employer self-audit component which is updated through machine learning risk reduction recommendations), aggregation of information to assist in prevention (employer has a one-stop dashboard with filters to view a snap shot slice of the organizations risk) and continual recommendations for improvement.

Also, the system can produce Software as a Service HR management tool including but not limited to insurance risk assessment profile, due diligence for mergers and acquisitions, audit risk profile, financial risks profile, consumer and corporate conduct identity, and employment agency monitoring.

The system is configured to permit upload of employees, contractors and vendors into the platform. The system determines the interval of background checks—either every six months or every twelve months. Background check results are stored in the dashboard with ability for the employer to filter by occupation, department, region and pass/fail status.

The system continually scores each worker based on identified occupational behaviors that are considered red flags and/or prerequisites for crime and fraud through APIS which track worker behavior within the organization's existing HRMS, Payroll and RMIS systems.

Relational database stores, metric score, history of checks, compliance training and educational certificates which can be ported to the next employer via encrypted file or blockchain per permission by employee, contractor or vendor.

System results of occupational behavior tracking are used to determine percentage of risk based on targeted preemptive fraud and crime behaviors. Additionally, customer feedback and culture pulse is displayed in the dashboard through complementary vendor partnerships. Within the Worker profile, the worker can sign in to update their compliance training, skills, educational certificates and anonymously report incidences of fraud or crime through our vendor partner. Essentially, the dashboard serves as a one stop risk barometer for the health of the workers and the organization as a whole.

Employer completes a chatbot based survey that queries nature of complaints made against employees, claims made against employees and current loss control measures taken to prevent crimes and fraud against third parties.

Information is collected in a cloud-based database to include employer's data and external data to include insurance underwriting and employer liability practices.

Artificial intelligence and machine learning provide recommendations to the employer to reduce their risk through a chatbot which is linked to the employer scoring mechanism. The survey inquires about existing policies surrounding financial crime, dual signatory processes and data protection policies.

Employer indicates which recommendations, in the form of policies and practices that they do not currently practice but wish to implement. The documents substantiating compliance are either shared and uploaded into the employer risk profile or stored on their own server in a folder designated as a system audit. In some embodiments, the documents will be scanned using artificial intelligence to confirm their content. Further, confirmation of documents and policies may be confirmed through an annual audit by a certified fraud examiner or our preferred employment counsel network.

Employer risk profile updates with percentage of risk reduction as they implement risk control procedures. For example, if Employer Metric score is within the range from 80 to 100%, their current loss control tools are considered satisfactory. If below 80, the employer is encouraged to shore up their current risk management program through the adoption of additional risk mitigation policies and practices as aforementioned.

Employer has the option to share their risk profile with their insurance agent or insurer for reduction in premiums via encrypted method or blockchain.

Employers can share their risk profile with legal counsel to defend against claims or lawsuits.

For worker risk scoring, the software can integrate with existing human resource platforms, payroll systems or risk management systems like SAP, ADP, Gusto and LogicManager via API. For the employer/organization risk scoring there is no external integration required and the platform serves as a standalone product with a built-in compliance recommendation engine.

The system uses a bank level secured SaaS based dashboard with a relational and non-relational database. Included is an API to a background check company. The steps for the background check through a FCRA vendor partner requires permission from the worker who is directed to a secure portal for identifying information and any follow-up to include a copy of the report. The employer does not receive a copy of the report and instead receives a status of Meets, Needs Review, or Pending per adjudication. In addition to these checks, crime related occupational behaviors are continually monitored and a metric score assessed based on point in time risk conditions.

Information from employer, external online compliance and insurance resources and legal loss control measures are aggregated in the cloud with decision support through machine learning and artificial intelligence to assess risk and recommend risk mitigation.

Secured storage of documents to support implementation of loss control and percentage risk assessment through data actualization. The employer's practices and policies will be stored on their server in a folder labeled by the system as Audit. In addition, a secured and encrypted cloud storage method may be utilized to store all Employer Risk Profile documents.

Encrypted method or blockchain may be used to port risk profile to agent, insurer or legal counsel.

The system includes API integration with human resource platforms.

The employer can utilize the platform for solely ongoing and automated checks with blockchain port to the next employer through authorization by the employee, contractor or vendor. If the employer wants a complete employer risk profile the checks are integrated into the cloud stack where machine learning and artificial intelligence combines employer risk data, responses and external loss control recommendations. The employer can assess their risk, implement changes and stop here. Or, if the employer wishes to do so, they can share their risk profile through encrypted method and/or blockchain.

The invention could utilize additional software to include containers, or decentralized MIST framework or Iota.

(1) The infrastructure includes an end to end infrastructure pipeline for data and information flow; a rules engine with externalized rules; containerized microservices; search and information retrieval; (2) ETL existing data into new system. (3) Risk Analysis services; rules-based risk assessment of the candidates; (4) Analytics services; (5) UI to include a full-fledged statistics and dashboard; risk score and prediction; demonstration of 2-3 employee workflows with smart contract based migration between employers.

Data ingestion from existing system mongo database and other data sources; Ingestion adaptor/agent will pull the data from respective data sources and stores data into normalized data store.

The background and occupational behavior check stack with portable check history can stand alone. The cloud-based machine learning and artificial intelligence stack can perform alone though lacking critical information obtained through the checks which provide the crime/fraud risk assessment.

Through following the above-listed steps, the user can perform an enterprise specific risk assessment and port the risk profile or background check history. Additionally, the invention can be used in the financial/banking industry to develop a risk profile of a client. The invention can be used as identity verification for business transactions. The invention can be utilized to conduct audits. In some embodiments, the system creates: Software as a Service HR management tool; Insurance risk assessment profile; Audit risk profile; Financial risks profile; Consumer conduct identity; Employment agency monitoring; Mergers and Acquisition due diligence; and Diagnostic loop for multiple industries to include healthcare, automotive and others.

### Example: Trucking Employer Use Case

Adding an Employer by Super Admin

Capture Name, Address and Industry for the company and then focus on the following variable aspects: NAIC Code—Trucking company→Drop down Ask and find out what is the sub-classification

Drop down below that is pre-populated based on selection above (Or ask other questions that allow inference to the codes below)

### 484121 General Freight Trucking, Long-Distance, Truckload

### 484122 General Freight Trucking, Long-Distance, Less Than Truckload

### 484210 Used Household and Office Goods Moving

484230 Specialized Freight (except Used Goods) Trucking, Long-Distance

Other inputs that may be needed:

### Automobile Body Repair Shops

### Automobile Repair Shops and Oil Change Centers

### Gasoline Stations

### Full-Service and Self-Service Moving and Storage Firms

### Public Warehouses Trucking

### Specialized Carriers

Company Demographics captured in Super Admin and Products and Monthly Subscription Dashboard selected with coupon codes as follows;
1. Worker IQ provides Risk Scoring information on the Employer's workers plus the organization's average overall worker risk score. Soft Risk Reduction Recommendations and Data Visualizations are included.
2. Employer IQ conducts a self-audit of the organization's policies and practices utilizing a chatbot to query each department such as; HR, IT, Payroll, etc. to provide a risk score for the organization.
3. Worker IQ and Employer IQ can be purchased together. If purchased together the Worker IQ total average worker score serves as the baseline for Employer IQ (this Risk Profile can be shared with Insurers and Brokers/Mergers and Acquisitions and others for a potential reduction in costs).

Employer receives login details to their portal based on the selected subscription above. Employer begins to add workers either manually or as a csv upload with required data fields. Employer can select the interval of specified risk checks and connect to existing HRMS, Payroll and Risk via API to pull occupational factors that are components of the worker's metric score based on the rules algorithm.

The system wants to capture worker details sufficient to pull records from the HRMS system or other uploads that the employer might use.
1. Name, Address, SSN last 4, DOB
2. Employee ID for this employer and worker (tied to relational database)
3. Role/Title of Employee—Ideally drop down with “Other” so that we can capture the typical roles that an employee plays in a trucking industry
   Occupation>>>Details
      a. Driver→Capture License details (CDL and Class), Driver Experience,
      b. Manager
      c. Cashier
      d. Mechanic
      e. Dispatcher
      f. Need list of worker classifications
4. Department

Background Checks performed.
1. MVR
2. Criminal
3. Licensing
4. Drug Test
5. Docket Search

Scoring Variables
1. Crime related insurance claims
2. Complaints about behavior/violence on job
3. Unexcused Absenteeism
4. Drug/Alcohol Abuse
5. Failure to take a vacation
6. Lack of Growth

The system continually updates Metric Score as changes in factor information occur resulting in a real-time risk assessment of the worker. The algorithm adjusts as new factors are added as additional data stories are discovered.

Employers can filter results by Region, Department, Occupation and Worker ID Details to track trends. Data Visualization Tables provide further insight into areas where risk control can be improved and to guide strategic management.

The system prompts about specific soft recommendations for safety and loss control that are provided within the platform and also in a printable format. For example, for the Employer:

Please adhere to 11-hour driving maximum limits. No driving may occur if more than 8 consecutive hours have passed since the last break of 30 minutes or more. The 14-hour driving window rule retains a 14-hour consecutive hour driving limit, with a 30-minute rest break. No driving can occur after 14 consecutive hours of driving since coming on duty. However, non-driving work is permitted past the 14-hour driving window. Waiting time at an oil well or natural gas site does not count toward calculation of the 14-hour driving window but is required to be recorded as off-duty within a driver's log. Finally, egregious violations can cost drivers and motor carriers stiff fines. Violations that can be deemed egregious include instances where a driver exceeds or a motor carrier permits a driver to exceed the driving time by three hours or more.

### For the Worker:

Please ensure no smoking close to the trucks
Please reinforce drug testing on start of employment and random checks during employment
Please ensure maintenance of logs while driving for time and any issues reported for equipment
Please ensure periodic training of all employees on compliance with latest regulation and safety practices

Partner Variables with Complementary Products—Anonymous Worker Reporting, Customer Feedback, Culture and Cyber Protection

Types of Liability:

Individual scores for each variable are represented from 1-10 based on defined bands. 1 indicates high risk and 10 is a lower risk band. The system can also keep a zero if needed to eliminate a score. Aggregate will be multiple of 3.33 to total of weighted score to achieve a number from 1 to 10. 1 being low risk and 10 being high risk. The system will also strive to find a normal curve for these attributes and then measure standard deviation as another measure.

Workers can improve their score and Risk Profile (“MyIQ”) through Compliance Training, Education and Licensing and Employer Strengths which become of part of the Worker profile. Skills from LinkedIn will eventually be linked to their profile. The Worker can request permission based sharing of their My IQ Profile with the next potential employer or business associate. Transfer will be executed through encrypted file transfer and smart contracts.

Employer IQ, if selected by the Employer, is a self-audit of the company's policies and practices to thwart worker crime. The self-audit consists of a series of questions which can be segmented by department and industry. An audit chatbot queries the department representative on their existing practices. A baseline score is determined which may or may not include the average organizational worker score (if Worker IQ is purchased) supportive documentation is stored in the company's audit file with recommendations made to improve processes. The employer can improve their score through the implementation of policies and procedures and through an annual audit (through certified fraud examiners and preferred employment counsel) to confirm documentation and compliance with current best practices. The employer can opt to share their risk profile with their insurer or broker for a reduction in premium and may wish to connect via the system to Canopy, the insurance industry's blockchain initiative and marketplace, to provide the opportunity for optimal pricing through connected insurers.

New recommendations are added on an ongoing basis through backend implementation within the rules engine workbench from online data scrapes from trusted compliance sources within the data cloud silos. As data is added to recommendations and results of implementations are tracked, machine learning helps to continually improve the recommendation engine based on data stories and emerging compliance advancements. This helps the platform to essentially serve as a diagnostic/recommendation loop. The system is to be used to reduce worker crime and employer liability and later to be utilized for other lines of insurance and other industries, wherein worker units are substituted with other variables (i.e., equipment with sensors or smart devices for health).

Those of skill in the art will appreciate that the various illustrative logical blocks, module, units, and steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends on the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, block, or step without departing from the invention.

The above description of the disclosed embodiments, and that provided in the accompanying documents, is provided to enable any person skilled in the art to make or use the invention. Various modifications to these embodiments will be readily apparent to those skilled in the art, and the generic principles described herein, and in the accompanying documents, can be applied to other embodiments without departing from the spirit or scope of the invention. Thus, it is to be understood that the description and drawing presented herein, and presented in the accompanying documents, represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein, or by the descriptions presented in the accompanying documents.

I claim:

1. A method to monitor, alert and predict precursory behavior, comprising the steps of:
determining a source of information specific to occupational behaviors;
obtaining from one or more of the determined sources, a plurality of predetermined factors associated with an organization and at least one employee of that organization; and
generating a risk score associated with the at least one employee and separately for the organization based on its employee's occupational behaviors.

2. The method according to claim 1, wherein the source of information available to the organization is at least one selected from the group consisting of a human resources department, payroll department, risk management department, and policies and procedures.

3. The method according to claim 2, wherein the organization filters the factors obtained from one or more of the determined sources by region, department, occupations, status, or employee details.

4. The method according to claim 3, wherein the risk score generated for the organization is compared to an identified benchmark.

5. The method according to claim 4, wherein the risk score of the organization is based on an average employee risk score for the entire organization.

6. The method according to claim 5, further comprising the steps of:
continuously updating the predetermined factors obtained from one or more of the determined sources;
analyzing the plurality of factors obtained from one or more of the determined sources of information available to the organization;
producing updated prediction models for recommendations; and
generating recommendations to the organization for improving the risk score and reinforcing compliance.

7. The method according to claim 6, wherein the organization responds to the recommendations, which is added to the predetermined factors associated with one or more of the determined sources based on a change in conditions and recommendations to reduce a risk.

8. The method according to claim 7, further comprising improving the risk score of the organization and the employee though compliance training and job related educational certificates.

9. The method according to claim 1, wherein the source of information available to the employee is the predetermined factors relied upon to develop the employee's risk score including background check information and occupational information from the organization for the employee.

10. The method according to claim 9, further comprising providing, by the employee, additional sources of information for improvement of the employee's risk score.

11. The method according to claim 10, wherein the additional sources of information include biographical data, social media data, and licenses and certifications of the employee.

12. The method according to claim 11, further comprising:
continuously updating the predetermined factors obtained from one or more of the determined sources;
producing updated prediction models for recommendations; and
generating recommendations to the employee for improving the risk score and reinforcing compliance.

13. The method according to claim 12, further comprising permission-based sharing of the employee's risk score through encryption or smart contracts.

14. The method according to claim 13, wherein the encryption is blockchain.

15. The method of claim 1, wherein obtaining a plurality of predetermined factors is from manual input or existing determined sources for ongoing and real time changes in the requisite predetermined factors to populate those applicable to the risk score.

16. The method of claim 14, wherein the predetermined factors are updated in real-time through smart devices.

17. A method to monitor, alert and predict precursory behavior, comprising the steps of:
determining a source of information specific to occupational behaviors;
obtaining from one or more of the determined sources, a plurality of predetermined factors associated with an organization and at least one employee of that organization;
generating a risk score associated with the organization based on its employee's occupational behaviors;
continuously updating the predetermined factors obtained from one or more of the determined sources;
analyzing the plurality of factors obtained from one or more of the determined sources;
producing updated prediction models for recommendations; and
generating recommendations to the organization for improving the risk score and reinforcing compliance.

18. A method to monitor, alert and predict precursory behavior, comprising the steps of:
determining a source of information specific to occupational behaviors;
obtaining from one or more of the determined sources, a plurality of predetermined factors associated with an organization and at least one employee of that organization;
generating a risk score associated with the at least one employee;
providing, by the employee, additional sources of information for improvement of the employee's risk score;
continuously updating the predetermined factors obtained from one or more of the determined sources;
producing updated prediction models for recommendations;
generating recommendations to the employee for improving the risk score and reinforcing compliance; and
permission-based sharing of the employee's risk score through encryption or smart contracts.
